(19) United States
(12) Patent Application Publication
(10) Pub. No.: US 2004/0047001 A1
(43) Pub. Date: Mar. 11, 2004

(54) Image selection using proof sheet

(76) Inventors: Shane T. Gehring, Meridian, ID (US); Vincent C. Skurdal, Boise, ID (US); Mark L. Brown, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/242,511

(22) Filed: Sep. 11, 2002

(51) Int. Cl. G06K 1/00; G06F 15/00

(52) U.S. Cl. 358/1.18; 358/1.5

(57) ABSTRACT

A proof sheet allows selection of objects for further processing with different options. Objects are selectable with different processing options for each object. A scanner is used to scan the proof sheet and identify the objects and corresponding processing options. In one embodiment, the objects are images, and the further processing is printing of the images.

### FIELD OF THE INVENTION

The present invention relates to image selection, and in particular to the use of a proof sheet for image selection.

### BACKGROUND OF THE INVENTION

Proof sheets contain representations of images, along with a bubble or other method of selecting desired images for further rendering, such as printing. In one prior device, a memory card with pictures is loaded into a combined printer and scanner. A button is pressed, and a proof sheet with thumbnail-sized photos is printed. The user then selects desired photos, paper type, quantity and size desired on the proof sheet, and uses the scanner to scan the proof sheet. The device recognizes the user's choices, and prints the photos as specified.

### SUMMARY OF THE INVENTION

A proof sheet allows selection of objects for further processing with different options. Objects are selectable with different processing options for each object. A scanner is used to scan the proof sheet and identify the objects and corresponding processing options. In one embodiment, the objects are images, and the further processing is printing of the images.

### BRIEF DESCRIPTION OF THE DRAWINGS

FIG. 1 is a block representation of a proof sheet.

FIG. 2 is a flow chart representing interaction of the proof sheet with a device.

FIG. 3 is a block diagram of a device that creates and utilizes the proof sheet of FIG. 1

FIG. 4 is a block representation of an alternative proof sheet.

FIG. 5 is a block representation of yet a further alternative proof sheet.

### DETAILED DESCRIPTION OF THE INVENTION

In the following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples.

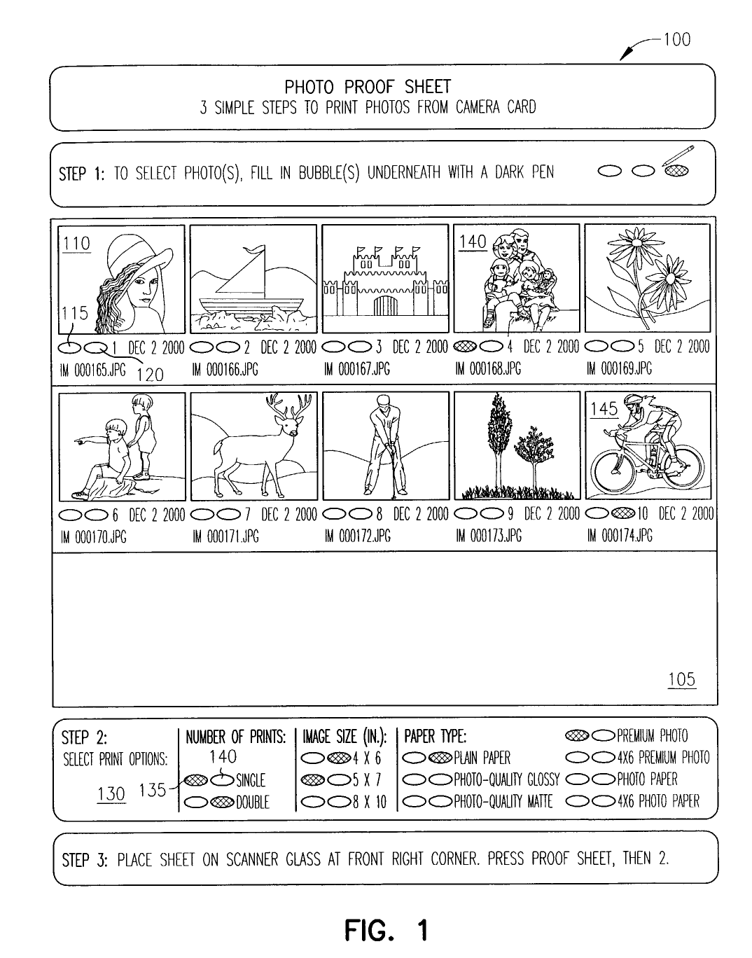

FIG. 1 is a block representation example of a proof sheet 100. The proof sheet comprises one or more images, each represented by a thumbnail image indicated generally at 105. Any type of image may be used to represent the images, such as a low resolution image, or even a high resolution image. In one embodiment, the size of the image is minimized to allow multiple image representations to be displayed on the proof sheet. In one embodiment, the proof sheet is filled in by a user and scanned to identify user selections for further processing such as printing.

Each image, such as image 110 has multiple image selectors, such as bubbles 115, 120 to enable a user to select images for further processing. In one embodiment, the image selectors for each image are located proximate the image and comprise two bubble shape outlines that can be filled in, such as by pen or other writing instrument. Filling in a bubble selects the corresponding image for further processing such as printing in a higher resolution format. Other processing may also be performed, such as compression and storage/transmission or other transformations of the images such as conversion to different formats. The proximity of the bubbles to the images in one embodiment provides a clear communication to the user regarding which bubbles correspond to which image. In FIG. 1, bubbles 115 and 120 correspond to image 110.

The proof sheet 100 also comprises option selectors indicated generally at 130. Each option selector comprises multiple bubbles in one embodiment, corresponding to the number of image selectors for each image. For example, a number of prints option has two bubbles 135 and 140 next to a “single” option designation. The positioning of the multiple bubbles, both for the image selectors and option selectors is consistent in one embodiment to ensure ease of use. The option selectors are spaced apart from the images and corresponding image selectors in one embodiment.

In the two bubble embodiment, a first and second bubble for both image selectors and option selectors are positioned on separate horizontal lines associated with the selections. Selecting the first bubble for an image and one or more first bubbles for the option or options results in the selected image being processed using the selected first bubbles for the options. Selecting the second bubble for an image will additionally result in the image being processed in accordance with selected second bubbles for the options. In further embodiments, more bubbles for image and option selectors are provided, and may be arranged in other formats, such as polygonal shapes as well as horizontal and vertical lines.

In the embodiment in FIG. 1, each image has associated first and second bubbles, a date, and file name for each image. Options comprise a number of prints for printing, a size for the image, and a paper type for printing. Several other options are used in further embodiments, such as emailing of the selected images, conversion of the images to a different format, archiving the images, etc. In operation, if both the first and second bubbles for an image selector are filled in, the image is first printed in accordance with the first bubbles filled in for options, and then the image is printed in accordance with the second bubbles filled in for options.

An example of how the proof sheet is used is also illustrated in FIG. 1. Different printing options are selected for two of the ten images shown in FIG. 1. A fourth image 140 has a first bubble filled in. A tenth image 145 has a second bubble filled in. Options for the fourth image 140 are represented by first bubbles in the options selectors 130. The first option bubble include single prints, 5×7, and premium photo. Thus, the fourth image 140 will print with these options. Options for the tenth image are represented by second bubbles in the options selectors 130. The second option bubbles include double prints, 4×6 image size, and plain paper. The second image will print with these options.

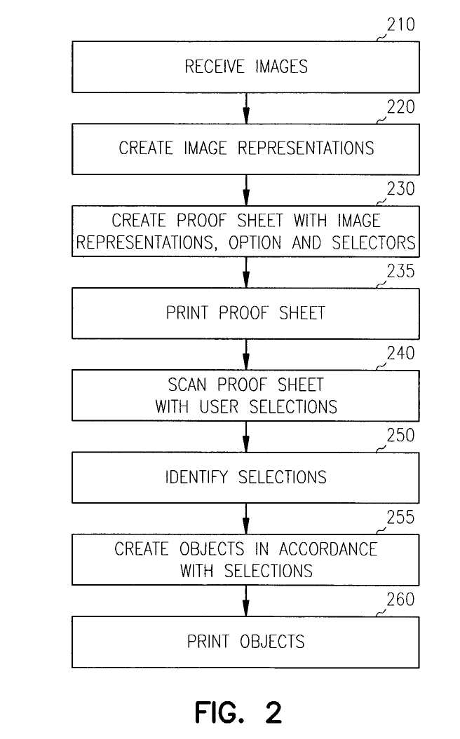

A flow chart indicating a method implemented by a machine is provided in FIG. 2. In one embodiment, the machine is a combination printer and scanner. The machine receives one or more images at 210 from a memory device, such as a memory card used in a digital camera, or from a file stored on the computer or accessed via a network. A set of thumbnail images is created at 220 as is a proof sheet in accordance with the proof sheet of FIG. 1 by placing multiple image selectors with the thumbnail images, and multiple options selectors with each option at 230. Instructions for using the proof sheet are also added to the sheet in one embodiment. The sheet is then printed at 235 for use by a user to make selections.

Once the user has made selections, the device scans the proof sheet at 240, and identifies the selections at 250. It recognizes which selectors have been filled in by the user, and then creates one or more objects 255 for printing at 260 or other processing in accordance with the images selected, and the options for each image. Each object contains a representation of the image and the options selected in one embodiment. In further embodiments, a further object or file may be used for the associated options.

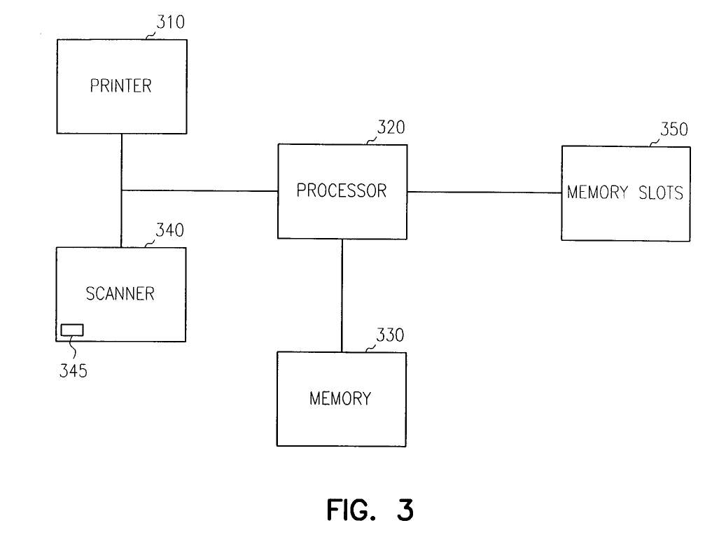

FIG. 3 is a block diagram of a device that creates and processes the proof sheets of FIG. 1 in accordance with the flowchart of FIG. 2. A printer 310 is coupled to a processor 320 that execute software stored in a memory 330. In a further embodiment, the processor is formed of firmware, or a combination of hardware, firmware, software or other constructs capable of performing the method in the flowchart of FIG. 2. A scanner 340 is also coupled to processor 320 and contains a proof sheet button 345 that indicates when a proof sheet is to be scanned. Processor 320 is further coupled to one or more memory slots 350, or other type of connection for receiving images or other objects for printing by printer 310. The connections between the processor, scanner and printer may be hardwired, wireless or any other type of communication mechanism providing for transfer of information therebetween.

The processor creates a proof sheet using information from memory devices plugged into the memory slots 350, or otherwise received by the processor. A user then selects bubbles on the proof sheet, and scans the proof sheet using scanner 340. Scanner 340 provides an image of the scanned proof sheet to processor 320, which identifies objects selected and corresponding options using a character/image recognition methods, such as one used to score standardized tests. By using the proof sheet button 345 on the scanner 340 the processor is informed that the image sent to it is a proof sheet image. The processor then creates an object for each image to be printed, and proceeds to provide the objects to printer 310 for printing. In further embodiments, the options may indicate other types of processing for images or objects received by the processor, and the processor processes the objects in accordance with the options selected.

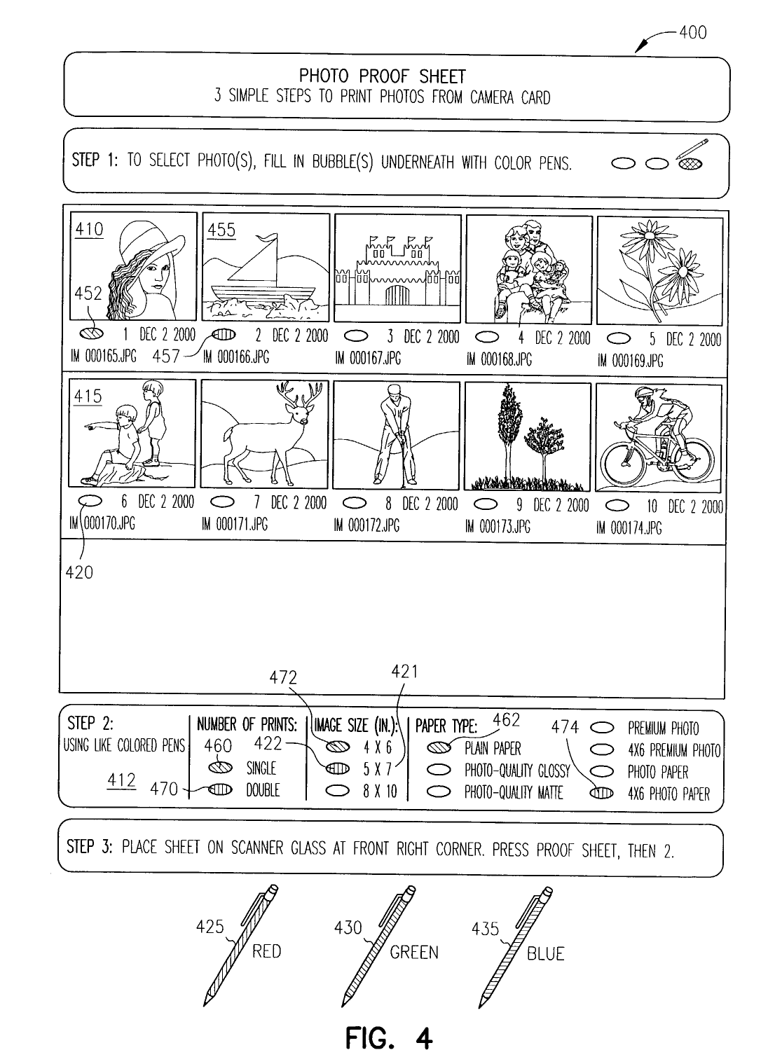

FIG. 4 is a block representation example of an alternative proof sheet 400. The proof sheet 400 comprises one or more images 410, each represented by a thumbnail image. Any type of image may be used to represent the images, such as a low resolution image, or even a high resolution image. In one embodiment, the size of the image is minimized to allow multiple image representations to be displayed on the proof sheet and to conserve consumables.

The proof sheet comprises a single bubble for each image for selecting the image, and a single bubble for each of one or more options 412. For example, an image 415 has an associated bubble 420. An option, image size 5×7 at 421 has associated bubble 422. In this embodiment, the user selects images and options using three different color pens 425, 430 and 435, such as red, green and blue, or other colors. Pictures selected with a red pen 425 will be further processed in accordance with options selected using the red pen. Pictures selected with different color pens will also be processed in accordance with options selected with the corresponding color pens. Options and pictures are selected by coloring in the bubbles or other shapes in further embodiments.

One example for selecting images is also represented in FIG. 4. A first picture indicated at 410 has a bubble 452 colored green, while a second picture 455 has a bubble 457 colored red. Option bubbles colored green include single prints 460, image size 5×7 at 421 and plain paper 462. Picture 410 will be processed with these options. Option bubbles colored red include double prints 460, image size 4×6 at 472, and 4×6 photo paper at 474. Picture 455 will be processed with these options.

When the proof sheet is placed on the scanner and is analyzed by the processor or control firmware of FIG. 3, the settings are identified, and matched to images and the corresponding options selected with the images. Objects for printing are then created and sent to the printer for printing.

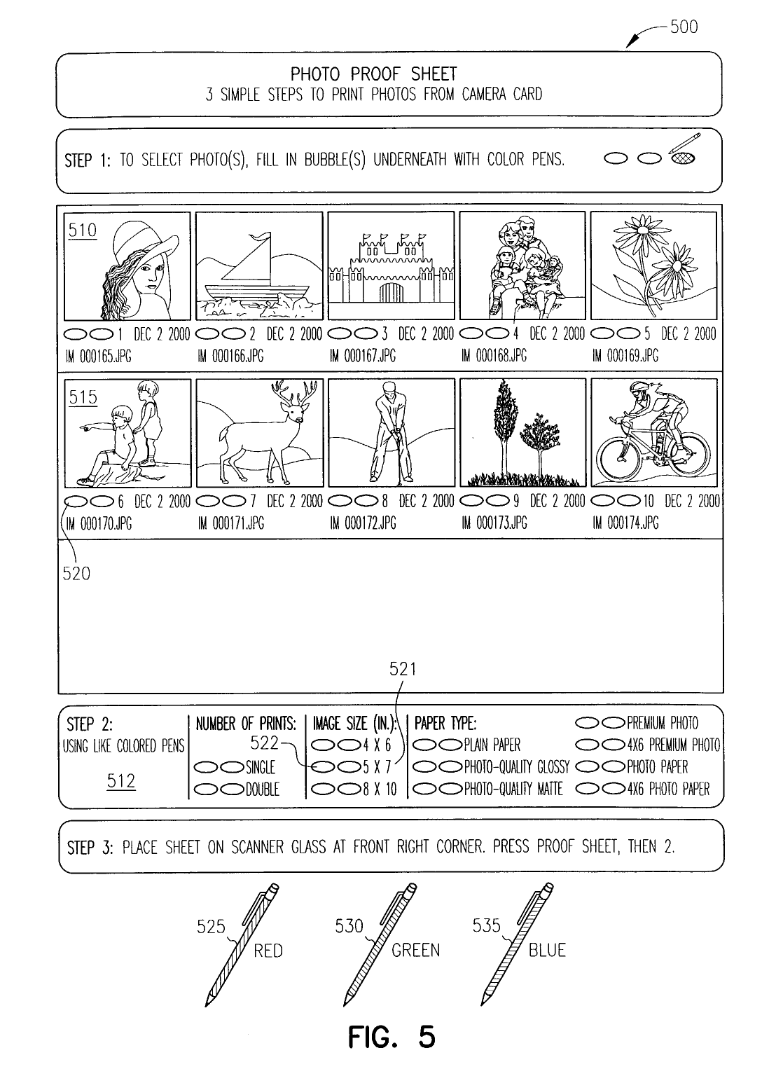

FIG. 5 is a block representation example of an alternative proof sheet 500. The proof sheet 500 comprises one or more images 510, each represented by a thumbnail image. Any type of image may be used to represent the images, such as a low resolution image, or even a high resolution image. In one embodiment, the size of the image is minimized to allow multiple image representations to be displayed on the proof sheet and to conserve consumables.

The proof sheet comprises a double bubble for each image for selecting the image, and a double bubble for each of one or more options 512. For example, an image 515 has associated bubbles 520. An option, image size 5×7 at 521 has associated bubbles 522. In this embodiment, the user selects images and options using three different color pens 525, 530 and 535, such as red, green and blue, or other colors. Pictures selected with a red pen 525 will be further processed in accordance with options selected using the red pen. With two bubbles for each picture and each option, the position of the bubble selected is also used to determine the options. In other words, if the second bubble of a picture is red, options having their second bubbles colored red are used to process the picture. Pictures selected with different color pens will also be processed in accordance with options selected with the corresponding color pens. The use of both different colors, and multiple bubbles further increases the ability to select different processing options for more pictures.

In further embodiments of the invention, different selector shapes, such as boxes, triangles, circles, etc. are used. The use of a single proof sheet for printing different type of images or pictures or other objects allows a reduction in consumables where such printing is desired. While printing is one form of processing selected images, other processing or transformations may also be identified via the proof sheet. The device that creates and processes the proof sheets is an all in one type of device, such as a combination printer, scanner and fax machine. In further embodiments, the devices may be separate stand alone devices that communicate directly with each other through a direct wired or wireless cable, or via a network. The processor may be located in one of the devices, or may further be implemented in a separate device such as a computer system.

1. A method of selecting images, the method comprising:
printing representations of images on a sheet;
providing multiple selectors per image;
providing printing options corresponding to each selector;
scanning a sheet having images selected as indicated by the selectors and corresponding options; and
printing images selected in accordance with the selectors and corresponding options.

2. The method of claim 1 wherein the representations of images are thumbnails of stored images.

3. The method of claim 1 wherein there are two image selectors proximate each image, and wherein the options are grouped together and spaced apart from the images.

4. The method of claim 3, wherein the images are grouped together separate from the options.

5. The method of claim 1 wherein the selectors and options comprise outlines of geometric shapes.

6. A machine readable medium for selecting images, the medium comprising:
multiple representations of images;
a plurality of image selectors corresponding to each representation of an image; and
a plurality of options corresponding to each image selector.

7. The medium of claim 6 wherein the representations of images are thumbnails of stored images.

8. The medium of claim 6 wherein there are two image selectors proximate each image, and wherein the options are grouped together and spaced apart from the images.

9. The medium of claim 8, wherein the images are grouped together separate from the options.

10. The medium of claim 6 wherein the selectors and options comprise bubbles.

11. The medium of claim 6 wherein the medium is scannable by a scanner.

12. A method of printing pictures, the method comprising:
scanning a sheet having representations of images, a plurality of selectors for each image, and at least one option for each selector, wherein the selectors and options are designated by a user;
identifying images and options designated; and
printing the images identified in accordance with the options.

13. The method of claim 12 wherein an option is represented by a bubble in a position corresponding to the position of the image selector.

14. The method of claim 13 wherein the representations of images and selectors for each image are located proximate to each other, and the options are spaced apart from the images and selectors.

15. The method of claim 13 wherein the bubbles are an outline of a geometric shape.

16. A computer readable medium having instructions for causing a device to perform a method of selecting images, the method comprising:
receiving a plurality of images;
printing representations of images on a sheet;
providing multiple selectors per image;
providing printing options corresponding to each selector;
scanning a sheet having images selected as indicated by the selectors and corresponding options; and
printing images selected in accordance with the selectors and corresponding options.

17. The method of claim 16 wherein images are received from a memory card.

18. The method of claim 17 wherein the images on the memory card are created by a digital camera.

19. The method of claim 16 wherein the selectors and options are outlines of a geometric shape.

20. A system comprising:
a printer;
a scanner;
a processor coupled to the printer and the scanner for generating a proof sheet having multiple images;
means for identifying images on the proof sheet that are selected for printing; and
means for identifying different options on the proof sheet for different selected images.

21. The system of claim 20 wherein the means for identifying images on the proof sheet is responsive to different colors on the proof sheet.

22. The system of claim 21 wherein the means for identifying different options is responsive to different colors on the proof sheet.

23. The system of claim 20 wherein the means for identifying images on the proof sheet is responsive to selected portions of the proof sheet being marked by a user.

24. The system of claim 23 wherein the means for identifying different options is responsive to selected portions of the proof sheet being marked by the user.

25. A method of selecting images, the method comprising:
printing representations of images on a sheet;
providing a selector for each image;
providing printing options corresponding to each selector;
scanning a sheet having images selected as indicated by the selectors and corresponding options, wherein selectors are indicated by using different colors, and wherein the options selected with one color are applied to the images selected with the same color; and
printing images selected in accordance with the selectors and corresponding options.

26. The method of claim 25 wherein multiple selectors are provided for each image.

27. A method of selecting objects for processing, the method comprising:
scanning a sheet having representations of objects, a plurality of selectors for each image, and at least one option for each selector, wherein the selectors and options are designated by a user;
identifying objects and options designated; and
processing the objects in accordance with the options.

28. A multiple function device comprising:
a printer;
a scanner communicatively coupled to the printer;
a processor coupled to the printer and the scanner for generating a proof sheet having multiple images, multiple selectors for each image, and multiple selectors for identifying different options on the proof sheet for different selected images; and
a proof sheet selector for the scanner.

29. A method of printing images, the method comprising:
printing representation of at least one image on a sheet;
providing multiple selectors per image;
providing printing options corresponding to each selector;
scanning a sheet having at least one image selected as indicated by the selectors and corresponding options; and
printing at least one image selected in accordance with the selectors and corresponding options.
